(19) United States
(12) Patent Application Publication
(10) Pub. No.: US 2008/0056155 A1
(43) Pub. Date: Mar. 6, 2008

(54) ACTIVE IDLE EXTENSION

(76) Inventors: Atte Lahtiranta, Mountain View, CA (US); Jari P. Hamalainen, Kangasala AS (FI); Ilop Karjalainen, Oulu (FI)

Correspondence Address: PERMAN & GREEN, 425 POST ROAD, FAIRFIELD, CT, 06824, US

(21) Appl. No.: 11/468,192

(22) Filed: Aug. 29, 2006

(51) Int. Cl. H04L 12/26

(52) U.S. Cl. 370/254

(57) ABSTRACT

The apparatus including a display and a processor connected to the display. The processor is configured to cause the display to present at least event and connection information pertaining to a user and one or more contacts independently of any communication protocol and/or service provider of the event, connection or the one or more contacts.

### CROSS REFERENCE TO RELATED APPLICATIONS

This application is related to the following U.S. patent applications: “UNIFIED CONTACT DATABASE”, Attorney Docket Number 684-012586-US (PAR); “VOICE MAIL EXTENSION”. Attorney Docket Number 684-012587-US (PAR); “REPLYING THROUGH DIFFERENT CHANNELS”, Attorney Docket Number 684-012588-US (PAR); and “MOBILE COMMUNICATION DEVICE”, Attorney Docket Number 684-012590-US (PAR), all of which were filed on Aug. 29, 2006, the disclosures of which are incorporated herein by reference in their entirety.

### BACKGROUND

1. Field

The disclosed embodiments relate to communication devices and, more particularly, to communication devices with multi-channel communication.

2. Brief Description of Related Developments

Mobile terminals, or mobile (cellular) telephones, for mobile telecommunications systems like GSM, UMTS, D-AMPS, and CDMA2000 have been used for many years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image or video recording, FM radio, music playback, exercise analysis, electronic games, calendar/organizer/time planner, word processing, etc. Furthermore, the modern terminals have local connectivity abilities, such as Bluetooth, allowing the mobile terminals to communicate with a wide array of devices.

With this great number of applications, user interaction naturally becomes complex and somewhat difficult. For example, in conventional communication terminals separate interfaces (e.g. screens) are used to communicate through or monitor different communication protocols that can be used with the communication terminal. The different protocols that can be used with a communication terminal include but are not limited to cellular communications, MMS, SMS, instant messaging, voice over IP, etc. In a conventional communications terminal there is generally a separate interface for each of these communication protocols and/or service providers corresponding to the communication protocols so that a user must continually switch between the various interfaces to obtain information pertaining to or use each of the protocols. For example, if a user of a conventional communications device wants to connect to a certain voice over IP service provider (e.g. log on) the user must find the user interface associated with that service provider to perform the log on. If the user of communications device wants to check the status of his/her connection pertaining to a particular service provider the user must, again, find the user interface associated with that service provider. Transitioning from one interface to another to gather information from each of the service providers and/or communication protocols can be tedious and bothersome to a user of the communication device.

One attempt to simplify the use of mobile terminals is to use two dimensional menus, allowing the user to see a large number of selectable applications simultaneously. However, switching from one application to the next is still a process which requires relatively intense attention by the user, even for the most common applications.

Consequently, it would be advantageous to be able to monitor a user's activity provided by different service providers/communications protocols in a single user interface.

### SUMMARY

In one embodiment, an apparatus is provided. The apparatus includes a display and a processor connected to the display. The processor is configured to cause the display to present at least event and connection information pertaining to a user and one or more contacts independently of any communication protocol and/or service provider of the event, connection or the one or more contacts.

In another embodiment, an apparatus is provided. The apparatus includes a display and a processor connected to the display. The processor is configured to merge a presentation of at least different communication protocols in a single user interface, the user interface is presented on the display.

In one embodiment, a method is provided. The method includes displaying at least information pertaining to an event or connection pertaining to a user and one or more contacts independently of any communication protocol and/or service provider of the event, connection or the one or more contacts.

In another embodiment, a computer program product is provided. The computer program product includes a computer useable medium having computer readable code means embodied therein for causing a computer to display at least information pertaining to an event or connection pertaining to a user and one or more contacts. The computer readable code means in the computer program product includes computer readable code means for causing a computer to display at least information pertaining to an event or connection pertaining to a user and one or more contacts independently of any communication protocol and/or service provider of the event, connection or the one or more contacts.

In one embodiment a user interface is provided. The user interface includes at least one display area configured to display at least a service availability of a communications device, at least one function of the communication device for selection by a user, at least one message corresponding to a communication received by the communication device and a user's connection status for at least one service provider.

In another embodiment, an apparatus is provided. The apparatus includes a means for displaying at least event and connection information pertaining to a user and one or more contacts independently of any communication protocol and/or service provider of the event, connection or the one or more contacts.

### BRIEF DESCRIPTION OF THE DRAWINGS

The foregoing aspects and other features of the disclosed embodiments are explained in the following description, taken in connection with the accompanying drawings, wherein:

FIG. 1 shows a schematic illustration of a communication system, as an example in which aspects of the invention may be applied;

FIG. 2A shows a device incorporating features of an embodiment;

FIG. 2B shows another device incorporating features of an embodiment;

FIG. 3 illustrates a user interface incorporating features of an embodiment;

FIG. 4 illustrates a schematic diagram of a device incorporating features of an embodiment; and

FIG. 5 is a block diagram of one embodiment of a typical apparatus incorporating features of the aspects of the invention that may be used to practice the present invention.

### DETAILED DESCRIPTION OF THE EXEMPLARY EMBODIMENT(s)

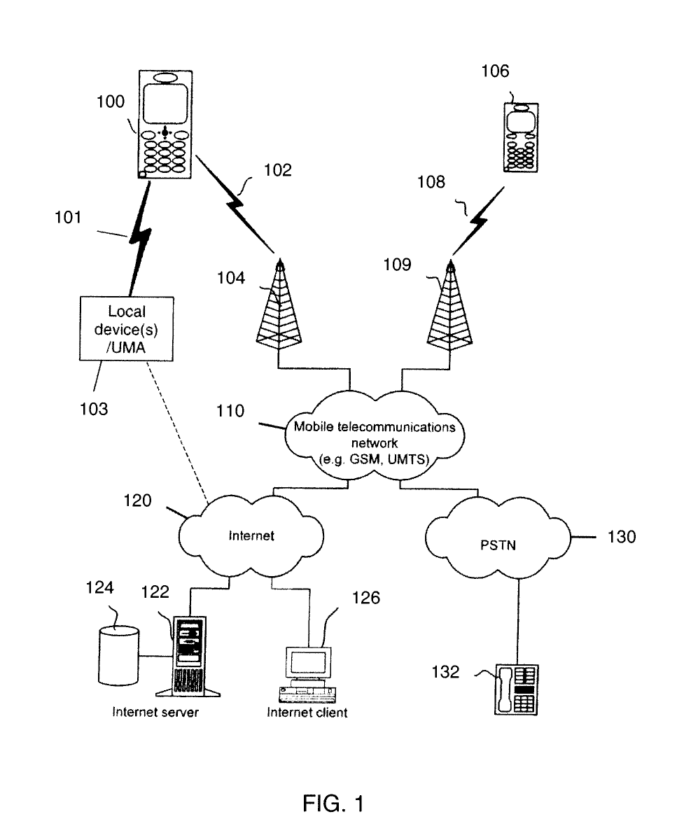

FIG. 1 illustrates a schematic illustration of a communication system, as an example, of an environment in which a communications device 100 incorporating features of an exemplary embodiment may be applied. Although the aspects of the invention will be described with reference to the exemplary embodiments shown in the drawings and described below, it should be understood that these aspects could be embodied in many alternate forms of embodiments. In addition, any suitable size, shape or type of elements or materials could be used.

In the telecommunication system of FIG. 1, various telecommunications services such as cellular voice calls, www/wap browsing, cellular video calls, data calls, facsimile transmissions, music transmissions, still image transmission, video transmissions, electronic message transmissions, electronic commerce and the like may be performed between the mobile terminal 100 and other devices, such as another mobile terminal 106 or a stationary telephone 132, or an internet server 122. It is to be noted that for different embodiments of the mobile terminal 100 and in different situations, different ones of the telecommunications services referred to above may or may not be available. The aspects of the invention are not limited to any particular set of services in this respect.

The mobile terminals 100, 106 may be connected to a mobile telecommunications network 110 through radio frequency (RF) links 102, 108 via base stations 104, 109. The mobile telecommunications network 110 may be in compliance with any commercially available mobile telecommunications standard such as GSM, UMTS, D-AMPS, CDMA2000, FOMA and TD-SCDMA.

The mobile telecommunications network 110 may be operatively connected to a wide area network 120, which may be the internet or a part thereof. An internet server 122 has data storage 124 and is connected to the wide area network 120, as is an internet client computer 126. The server 122 may host a www/wap server capable of serving www/wap content to the mobile terminal 100.

For example, a public switched telephone network (PSTN) 130 may be connected to the mobile telecommunications network 110 in a familiar manner. Various telephone terminals, including the stationary telephone 132, may be connected to the PSTN 130.

The mobile terminal 100 is also capable of communicating locally via a local link 101 to one or more local devices 103. The local link 101 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 103 can, for example, be various sensors that can communicate measurement values to the mobile terminal 100 over the local link 101. The local devices 103 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 100 may thus have multi-radio capability for connecting wirelessly using mobile communications network 110, WLAN or both. Communication with the mobile telecommunications network 110 may also be implemented using WiFi, WiMax, or any other suitable protocols, and such communication may utilize unlicensed portions of the radio spectrum (e.g. unlicensed mobile access (UMA)). The above examples are not intended to be limiting, and any suitable type of link may be utilized.

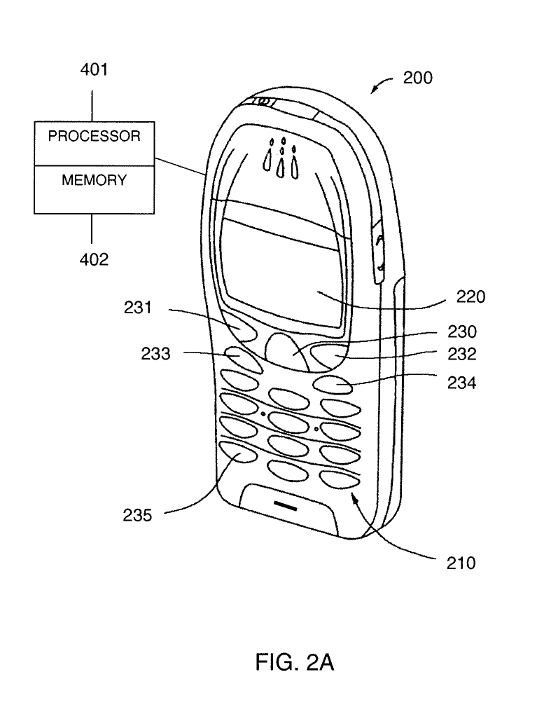

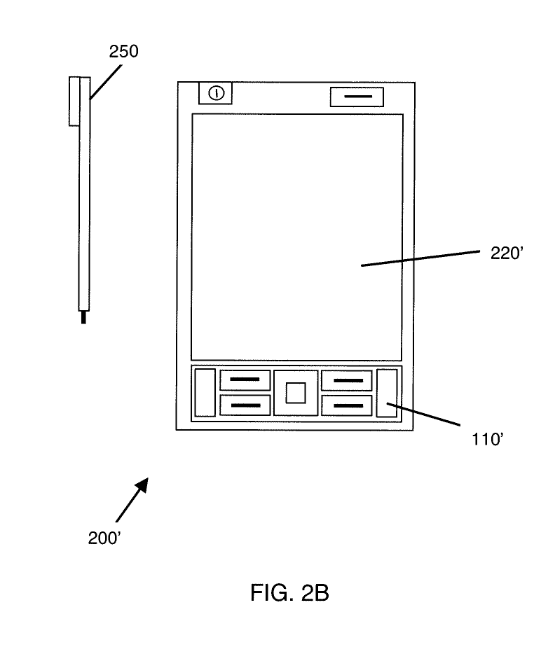

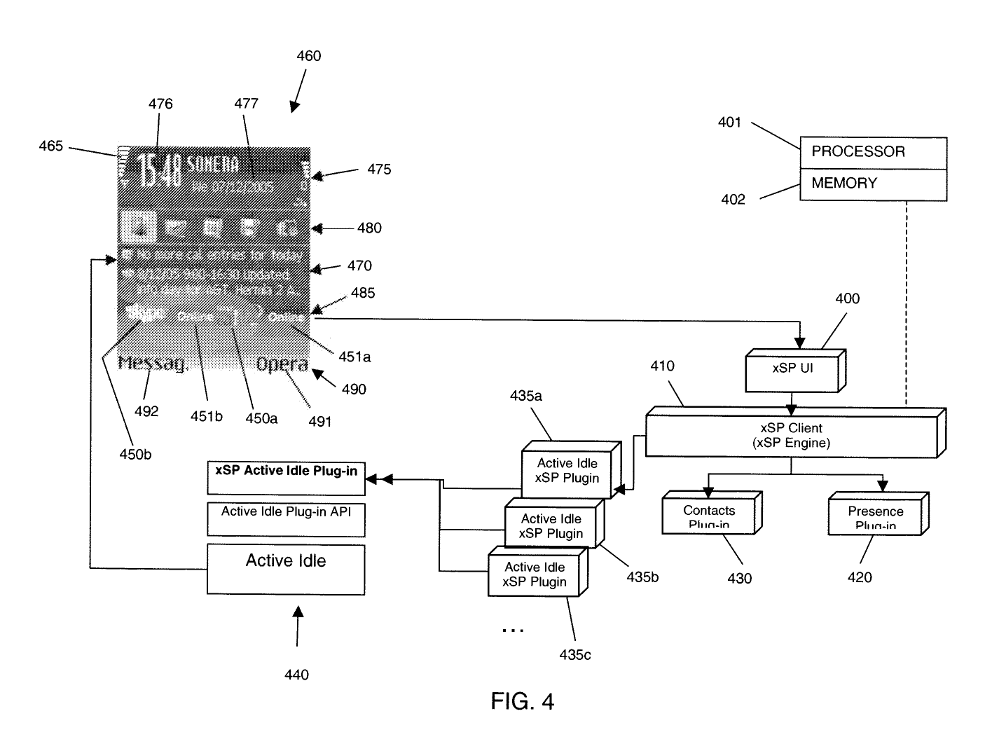

One embodiment 200 of a terminal 100 is illustrated in more detail in FIG. 2A. The terminal or mobile communications device 200 may have a keypad 210 and a display 220. The keypad 210 may include any suitable user input devices such as, for example, a multi-function/scroll key 230, soft keys 231, 232, a call key 233, an end call key 234 and alphanumeric keys 235. The display 220 may be any suitable display, such as for example, a touch screen display or graphical user interface. The display may be integral to the device 200 or the display may be a peripheral display connected to the device 200. A pointing device, such as for example, a stylus, pen or simply the user's finger may be used with the display 220. In alternate embodiments any suitable pointing device may be used. In other alternate embodiments, the display may be a conventional display. The device 200 may also include other suitable features such as, for example, a camera, loud speaker, connectivity port or tactile feedback features. The mobile communications device may have a processor 401 (see also FIG. 4) connected to the display for processing user inputs and displaying information on the display 220. A memory 402 (see also FIG. 4) may be connected to the processor 401 for storing any suitable information and/or applications associated with the mobile communications device 200 such as phone book entries, calendar entries, etc.

In one embodiment, the device 200, may be for example, a PDA style device 200′ illustrated in FIG. 2B. The PDA 200′ may have a keypad 210′, a touch screen display 220′ and a pointing device 250 for use on the touch screen display 220′. In still other alternate embodiments, the device may be a personal communicator, a tablet computer, a laptop or desktop computer, a television or television set top box, or any other suitable device capable of containing the display 220 and supported electronics such as the processor 140 and memory 150. The exemplary embodiments herein will be described with reference to the mobile communications device 200 for exemplary purposes only and it should be understood that the embodiments could be applied equally to any suitable device incorporating a display, processor, memory and supporting software or hardware.

The device 200 may be configured to provide communications over multiple channels or protocols such as, for example, Voice Over IP, instant messaging, cellular phone services, wireless broadband services, SMS, MMS, push-to-talk over cellular and the like. Referring to FIG. 4, the device may include a service provider user interface 400 and a service provider client 410 that may be implemented through the processor 401, and memory 402. In alternate embodiments, the service provider user interface 400 and a service provider client 410 may be implemented in any suitable manner.

The service provider user interface 400 may provide, via the display 220, a user of the device 200 with the information the user would receive when using a certain communication channel/protocol associated with a respective service provider. For example, if a user of the device 200 is sending an instant message, the service provider user interface 400 may provide information pertaining to an online status of the user (with respect to the particular service provider), a user name of the recipient of the instant message and the like. The service provider interface may also be configured to provide application inter-working between an active user interface such as the interface 460 and inactive applications such as, for example, a contacts list or phone book.

The service provider client 410 may manage the different service providers for each of the communication channels/protocols that can be used with the device. For example, the service provider client 410 may launch an active idle plug-in application program interface 440. The application program interface 440 may combine any number of active idle plug-ins, for example, plug-ins 435a-c. Each of the plug-ins 435a-c may be associated with a respective service provider (e.g. each service provider may have its own respective active idle plug-in) so that the channel/protocol and service providers that can be used with the communication device 200 may be displayed in a single user interface on the display 220 of the device 200. In alternate embodiments, more than one service provider may be associated with one active idle plug-in. For example, active idle plug-in 435a may be an instant messaging plug-in through which information for service provider “A” and service provider “B” is supplied to the interface 460. In one embodiment, for example, active idle plug-in 435b may be a voice over IP plug-in through which information for voice over IP service providers “C”, “D” and “E” is supplied to the interface 460. In alternate embodiments, any suitable number of service providers corresponding to any suitable communication protocol may be associated with an active idle plug-in. In alternate embodiments, information related to the different communication protocols and service providers may be displayed on or near keys of the keypad of the device. For example, an online status of the user with respect to each service provider may be indicated through, for example, an illumination of an LED or key that may correspond to a respective service provider.

The service provider client 410 may also determine the presence of the user's contacts on a certain channel/protocol associated with a service provider via a presence plug-in 420 or provide a screen name of a contact associated with a service provider via a contacts plug-in 430. The presence plug-in 420 and contacts plug-in 430 may gather information from, for example the phone book with respect to service provider information associated with the user's contact information. The phone book may be a phone book as described in co-pending application entitled “UNIFIED CONTACT DATABASE”, Attorney Docket Number 684-012586-US (PAR), the disclosure of which is incorporated herein in its entirety. In one embodiment, the phonebook may correlate a nickname assigned to the caller (e.g. the name of the caller in the phonebook) by a user of the device 200 with, for example, the user names assigned to the caller by a service provider.

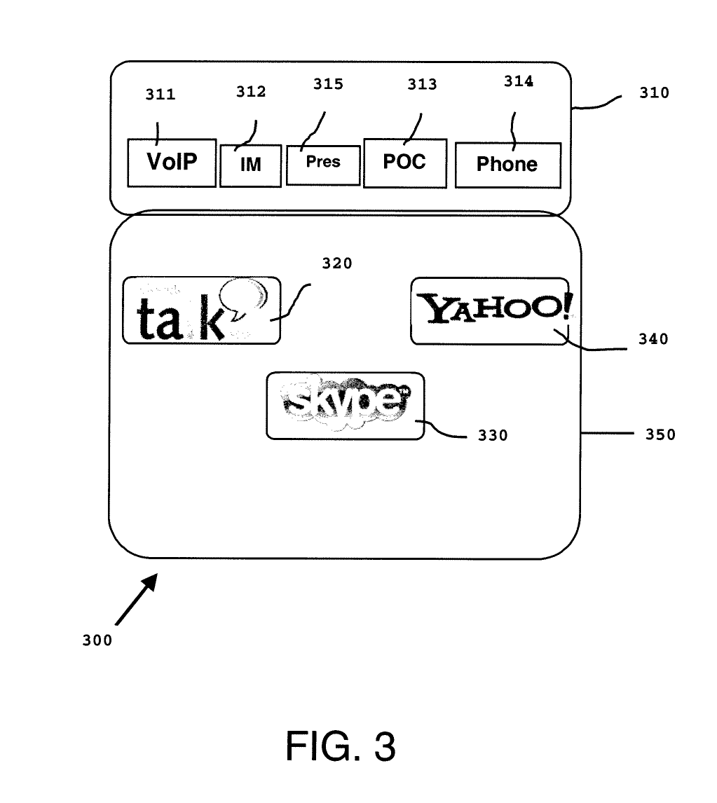

The device 200 may combine two or more service providers and/or communication channels/protocols into, for example, any suitable number of displays for presentation to and selection by a user. In alternate embodiments, the device 200 may include separate modules or apparatus corresponding to a respective service provider. The device 200 may utilize, for example, two-way icons, texts, notifiers and the like to indicate to the user the status of a particular service provider (e.g. logged in status, logged out status, away status, missed event such as IM, email, call, etc.). Information pertaining to the different service providers and/or communication channels/protocols that can be used with device 200 may be presented to a user through the display of FIG. 3. FIG. 3 illustrates one embodiment of a user interface 300 that includes a display of and links to some of the different communication channels/protocols and service providers that are available to be used or accessed with the device 200. The user may navigate to and select the links to the different service providers and/or communication channels/protocols to for example, change the status with respect to a particular service provider. In alternate embodiments, the device 200 may be configured to allow the user perform actions common to all or any user selected number of the service providers and/or communication channels/protocols. For example, a user may log in to, log out of, set an away status and the like for all selected service providers simultaneously (e.g. without having to, for example, log in to each service separately).

When, for example, a user selects a service provider and/or communication channel/protocol the device 200 may perform different events depending on the user's status for the selected service provider and/or communication channel/protocol. For example, if a user selects a particular service provider for which the user's status is “logged out”, the device 200 may display a home screen for that particular service provider or proceed directly to the service provider's login screen. If for example, the user's status is “logged in” the device 200 may be configured to display a home screen for the selected service provider. If there is a missed event for a service provider, the device 200 may display a home screen for the selected service provider and present to the user the missed events (e.g. missed calls, messages, etc.). If the user's status for a service provider is “away” the device 200 may display a home screen for the selected service provider and allow the user to change the user's status. The device may also be configured to display to the user textual or other graphical notifications such as for example, news tickers, advertisements, etc. corresponding to a particular service provider and/or communication channel/protocol. The device may be configured so that device displays information pertaining to a particular service provider and/or communication channel/protocol (e.g. the user's status, advertisements, news tickers, etc.) as the user points to, but does not select, an icon for the particular service provider and/or communication channel/protocol.

As shown in FIG. 3, the user interface 300 may include two sections 310, 350. In alternate embodiments, the user interface 300 may include any suitable number of sections or areas containing any suitable information, menu items or selections available to a user. The user interface 300 may provide a user with a centralized place in the device 200 for accessing or selecting the service providers and/or communication channels/protocols associated with the device.

In one embodiment, the first section 310 of the user interface 300 may display a menu or selection of any suitable number of communication channels/protocols such as, for example, Voice over IP 311, instant messaging 312 and push to talk over cellular 313, cellular communications 314, presence 315 and the like. In alternate embodiments, the first section 310 may include any suitable information or menu items available to the user. A user may be able to scroll the menu of the first section 310 up, down, left or right using, for example, the multifunction key 230 or a pointing device, to access additional communication channels/protocols. The first section 310 may also include a presence feature 315 so a user may determine if a party to be communicated with (e.g. the user's contacts) is present, also referred to as “on-line”, on that communication channel/protocol. For example, if a user A is logged into, for example, service provider “A” and wants to communicate with user B, user A can use the presence feature 315 to determine if user B is also logged into service provider “A”. The presence feature 315 may gather information from the phone book through the presence plug-in 420 as described above. In alternate embodiments, the menu 310 may include any suitable items such as SMS and other protocols.

The second section 350 of the user interface 300 may display an indication of the different service providers associated with the different communication channels/protocols that are presented in the menu of the first section 310. The user interface 300 may be configured so that as a user scrolls through the menu of the first section 310 a list of different service providers associated with that communication protocol may be presented to the user for selection in the second section 350 of the user interface 300. For example, in FIG. 3, when a user selects a communication protocol such as, for example voice over IP 311, the available service providers will be displayed for selection in section 350, such as for example GOOGLE TALK™ 320, SKYPE™ 330 and YAHOO!® 340. Service providers that may be displayed when a user selects the instant messenger protocol 312 may include, for example, AOL® (America Online) instant messenger, YAHOO!® instant messenger, ICQ® instant messenger and MSN® (Microsoft Network) instant messenger. In alternate embodiments, any suitable service providers may be included for a respective one of the menu categories (e.g. 310-313) presented in the first section 310. In this example, the second section 350 of the user interface 300 is configured to display the logo or icon associated with a respective service provider. In alternate embodiments any suitable indicator of the service providers may be utilized.

In this example, the user interface 300 includes a first section 310 and a second section 350 as described above. However, in alternate embodiments, the user interface may include a single section incorporating all of the features of the first and second sections 310, 350. In other alternate embodiments, the features described above with respect to the first and second sections 310, 350 may be divided into more than two sections wherein each of the sections contains any combination of the features described above.

A user of the device 200 may log on to any suitable service provider via the user interface 300. After logging on to the service provider or providers the user may not use the communication device 200 for a period of time. After a predetermined amount of time has lapsed without the device being operated or used, the device 200 may be configured so that, for example, the processor 401 causes an idle screen or interface to be displayed on the display 220. The idle interface may be, for example, the idle interface 460 shown in FIG. 4. The predetermined time period for the activation of the idle interface 460 may be defined during manufacture of the communication device or it may be user definable through, for example any suitable settings menu of the device. In alternate embodiments, the user may manually activate the idle interface 460 via, for example, any suitable key or input of the device 200. The idle interface 460 may allow a user to monitor or handle events such as communications (e.g. cellular, voice over IP, email, instant messaging, SMS, MMS, etc.), functions (e.g. calendar, notepad, etc.) and other events (e.g. missed calls, event timers, etc.) pertaining to the mobile device 200 via one user interface regardless of which service provider or communication protocol is being used.

One embodiment of an idle interface 460 shown in FIG. 4 may include, for example, five sections. In alternate embodiments, the idle interface 460 may include any suitable number of section that present any suitable information, menus or selection items that are available to the user.

The first section 475 may display, for example, the date 477 and time 476 and signal or service strength/availability 465.

The second section 480 may display a function/application menu from which the user may, for example, select a function of the device 200. The function menu of the second section 480 may allow a user to access any function/application of the device such as for example, email, calendar, phone book, calculator, games, etc. A user may scroll through the function menu 480 with, for example, the scroll key 230 to access additional functions/applications that are available for selection by the user.

The third section 470 may display messages for the user to read. The messages 470 may be any suitable message such as, for example, messages pertaining to received messages or calls (e.g. missed IM, SMS, MMS and/or email messages, cellular or voice over IP calls and the like), a users status pertaining to the communication protocols/service providers (e.g. online or offline status), a buddies status pertaining to the communication protocols/service providers (e.g. the online or offline status of the user's contacts) and calendar entries (e.g. appointments, etc.) such as for example, daily calendar activities, appointment reminders and the like.

The fourth section 485 of the idle interface may display the user's status 451a, 451b (e.g. online/offline status) pertaining to the communication protocol/service providers 450a, 450b associated with the communication device 200. It is noted that the service providers 450a, 450b shown in FIG. 4 are only examples of the service providers that can be used with the device 200. In alternate embodiments, any suitable service providers may be displayed in section 485 of the idle interface 460.

The fifth section 490 of the idle interface 460 may display, for example, soft functions 491, 492 of the device 200 that may be accessed with the soft keys 231, 232. The soft functions may be, for example, links to functions of the communication device 200 such as for example, a messaging function, a function to decline incoming calls and send the call to voice mail, voice dialing, etc. While only two soft functions 491, 492 are shown in FIG. 4, in alternate embodiments, any suitable number of soft functions may be displayed for selection by the user via any suitable number keys on the communications device.

The idle interface 460 may also include a timer to indicate to the user how long the communication device has remained idle (e.g. the time the user has not used the communications device). It is noted that the arrangement of information shown in idle interface 460 is exemplary in nature and the information may be arranged for presentation to the user of the device 200 in any suitable manner.

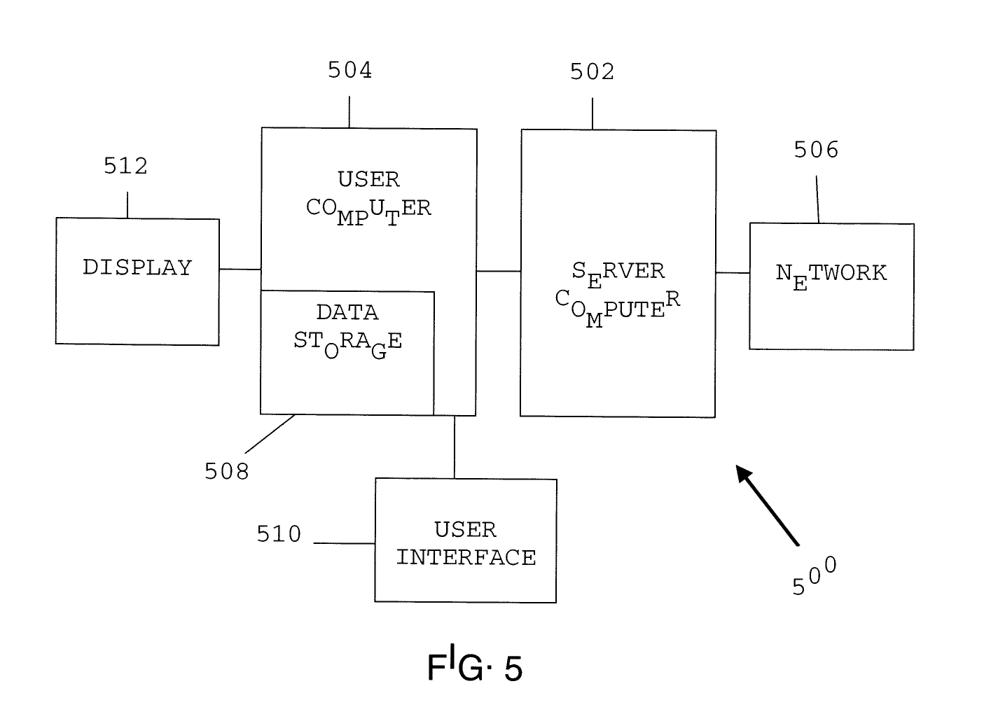

The disclosed embodiments may also include software and computer programs incorporating the process steps and instructions described above that are executed in different computers. FIG. 5 is a block diagram of one embodiment of a typical apparatus 500 incorporating features that may be used to practice the present invention. As shown, a computer system 502 may be linked to another computer system 504, such that the computers 502 and 504 are capable of sending information to each other and receiving information from each other. In one embodiment, computer system 502 could include a server computer adapted to communicate with a network 506. Computer systems 502 and 504 can be linked together in any conventional manner including, for example, a modem, hard wire or wireless connection, or fiber optic link. Generally, information can be made available to both computer systems 502 and 504 using a communication protocol typically sent over a communication channel or through a dial-up connection on ISDN line. Computers 502 and 504 are generally adapted to utilize program storage devices embodying machine readable program source code which is adapted to cause the computers 502 and 504 to perform the method steps of the present invention. The program storage devices incorporating features of the invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 502 and 504 may also include a microprocessor for executing stored programs. Computer 502 may include a data storage device 508 on its program storage device for the storage of information and data. The computer program or software incorporating the processes and method steps incorporating features of the present invention may be stored in one or more computers 502 and 504 on an otherwise conventional program storage device. In one embodiment, computers 502 and 504 may include a user interface 510, and a display interface 512 from which features of the present invention can be accessed. The user interface 510 and the display interface 512 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the disclosed embodiments are intended to embrace all such alternatives, modifications and variances which fall within the scope of the appended claims.

What is claimed is:

1. An apparatus comprising:
a display; and
a processor connected to the display, the processor being configured to cause the display to present at least event and connection information pertaining to a user and one or more contacts independently of any communication protocol and/or service provider of the event, connection or the one or more contacts.

2. The apparatus of claim 1, wherein the processor is configured to cause the display to present the user's connection status for each service provider.

3. The apparatus of claim 1, wherein the processor is configured to cause the display to present information including messages corresponding to missed communications received by the communications device.

4. The apparatus of claim 1, wherein the processor is configured to cause the display to present an indicator of how long the apparatus has been idle.

5. The apparatus of claim 1, wherein the processor is configured to cause the display to present information pertaining to a service provider connection status for a contact of the user.

6. An apparatus comprising:
a display; and
a processor connected to the display, the processor being configured to merge a presentation of at least different communication protocols in a single user interface, the user interface being presented on the display.

7. The apparatus of claim 6, wherein the processor is further configured to cause the display to present, in the user interface, at least one communication service provider corresponding to a respective communication protocol.

8. The apparatus of claim 7, wherein the processor is configured to cause the display to present, in the user interface, a user's connection status for each service provider.

9. The apparatus of claim 6, wherein the processor is configured to cause the display to present the different communication protocols in a menu of the user interface.

10. A method comprising:
displaying at least information pertaining to an event or connection pertaining to a user and one or more contacts independently of any communication protocol and/or service provider of the event, connection or the one or more contacts.

11. The method of claim 10, further comprising displaying information pertaining to the user's connection status for each of the service providers.

12. The method of claim 10, wherein the information includes messages pertaining to missed communications received by the communications device.

13. The method of claim 10, wherein the information includes an indicator of how long the user has been idle.

14. The method of claim 10, wherein the information includes information pertaining to a service provider connection status for the one or more contacts.

15. The method of claim 10, wherein the information is displayed in a single user interface of the device.

16. A computer program product comprising:
a computer useable medium having computer readable code means embodied therein for causing a computer to display at least information pertaining to an event or connection pertaining to a user and one or more contacts, the computer readable code means in the computer program product comprising:
computer readable code means for causing a computer to display at least information pertaining to an event or connection pertaining to a user and one or more contacts independently of any communication protocol and/or service provider of the event, connection or the one or more contacts.

17. The computer program product of claim 16, further comprising computer readable code means for causing a computer to display information pertaining to the user's connection status for each service provider.

18. The computer program product of claim 16, wherein the information includes messages pertaining to missed communications received by the communications device.

19. The computer program product of claim 16, wherein the information includes an indicator of how long the communication device has been idle.

20. The computer program product of claim 16, wherein the information includes information pertaining to a service provider connection status the one or more contacts.

21. A user interface comprising:
at least one display area configured to display at least a service availability of a communications device, at least one function of the communication device for selection by a user, at least one message corresponding to a communication received by the communication device and a user's connection status for at least one service provider.

22. The user interface of claim 21, further comprising at least a fifth area configured to display a service provider connection status for a contact of the user.

23. The user interface of claim 21, wherein the first, second, third or fourth area is configured to display a timer indicating an amount of time for which the communication device is idle.

24. An apparatus comprising:
a means for displaying at least event and connection information pertaining to a user and one or more contacts independently of any communication protocol and/or service provider of the event, connection or the one or more contacts.
